(19) United States
(12) Patent Application Publication
(10) Pub. No.: US 2006/0294538 A1
(43) Pub. Date: Dec. 28, 2006

(54) Inserting advertising content into video programming

(75) Inventors: Yin Li, Beijing (CN); Eyal Ofek, Beijing (CN); Ying Li, Bellevue, WA (US); Yasuyuki Matsushita, Beijing (CN); Li Li, Issaquah, WA (US); Ying-Qing Xu, Beijing (CN)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/166,444

(22) Filed: Jun. 24, 2005

(51) Int. Cl. H04N 7/173

(52) U.S. Cl. 725/24; 725/88; 725/102

(57) ABSTRACT

A system and a method for inserting content into a video. A portion of the video is received from a content provider, and data identifying insertion locations in the video is stored. Information describing the video and the insertion locations is received from the content provider. An interface is provided to allow users to view at least a portion of the received information or a portion of the video. A plurality of bids is receiving from the users. Each of the bids relates to insertion of a piece of content into one of the insertion locations. A winning bid is selected from the plurality of bids, and information associated with the winning bid is communicated to the content provider.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Since their introduction, digital video recorder (“DVR”) devices have revolutionized the passive relationship between people and their televisions. With a DVR device, viewers no longer have to stick to a TV schedule, and they can record and watch their favorite shows anytime they desire. Further, more and more viewers are fast-forwarding through commercials. Because of these benefits, the DVR market is growing fast. According to some estimates, DVR penetration rate in the US will reach above 40% by the end of year 2010. This trend will inevitably lead to a fragmented media market and a proliferation of video programming.

Just as DVR has altered the viewing of television programs, it has also changed the landscape of television advertising. Today more than 50% of television content is supported by ad revenue, but a DVR makes it easy for viewers to skip the ads. Of course, loss of ad revenue will greatly affect the industry. To compensate for ad revenue decline, cable networks may have to charge a higher subscription fee, and broadcast networks, which rely almost exclusively on ad revenue, will have to find innovative ways to generate revenue.

To compensate for the new viewing habits of DVR users, more and more content providers are integrating ads into video content itself. Ads that are placed into the content or “product placement” ads are designed to make the advertisements part of the viewing experience. For example, the characters in a show may drink a certain brand of soda, or an advertiser's billboard may persist in the background of a shot. However, today's marketplace for product placement ads is inefficient in that media providers and advertisers have limited means to communicate their respective offerings. While a great deal of communication and collaboration is necessary to incorporate a product into video content, currently there is no centralized marketplace where content providers can meet with advertisers. Of course, this insufficient information exchange causes market inefficiencies and decreases the price that media providers can receive for the ad slots they offer in their video content. As the video content market continues to fragment, this inefficiency will only increase. Further, special effect agencies today are paid between $10,000 and $90,000 to dub an ad into a short scene. With this hefty price tag, it is clear that there are currently insufficient digital authoring tools and services available for incorporating advertisers' content into programming. Accordingly, there is a need for improved techniques for managing the insertion of advertising content into video programming.

### SUMMARY

The present invention meets the above needs and overcomes one or more deficiencies in the prior art by providing a system and method for inserting content into a video. In one aspect of the present invention, a computer-implemented method for managing insertion of content into a video is provided. A portion of the video is received from a content provider, and data identifying insertion locations in the video is stored. Information describing the video and the insertion locations is received from the content provider. An interface is provided to allow users to view at least a portion of the received information or a portion of the video. A number of bids is receiving from the users. Each of the bids relates to insertion of a piece of content into one of the insertion locations. A winning bid is selected from the bids, and information associated with the winning bid is communicated to the content provider.

In another aspect of the present invention, a computer system for managing insertion of content into one or more videos is provided. The system includes data stores containing one or more videos. A slot identification component is also included. The slot identification component is configured to receive inputs identifying slots in the videos for inserting content. A ranking component configured to rank requests from users is provided. The requests include offers seeking to insert additional content into a video. The system also includes a content placement component configured to insert content into a video.

In yet another aspect of the present invention, a method for inserting advertising content into a piece of media is provided. One or more portions of the media are identified as ad locations acceptable for inserting advertising content. An advertiser interface is provided for allowing advertisers to view information associated with the piece of media and/or the ad locations. A number of bids is receiving from the advertisers. Each of the bids includes a request to insert advertising content into one of the ad locations, and a winning bid is selected from the bids. An insertion interface is provided for controlling insertion of advertising content into an ad location.

### BRIEF DESCRIPTION OF THE SEVERAL VIEWS OF THE DRAWINGS

The present invention is described in detail below with reference to the attached drawing figures, wherein:

FIG. 1 is a block diagram of an environment suitable for use in implementing the present invention;

FIG. 2 is a flow diagram showing a method for managing insertion of content into a video in accordance with an embodiment of the present invention;

FIG. 3 is a block diagram of a system for managing insertion of content into videos in accordance with an embodiment of the present invention;

FIG. 4 is a flow diagram showing a method for inserting adverting content into a piece of media in accordance with an embodiment of the present invention; and

FIGS. 5A and 5B are a flow diagram that illustrates a method for placing product placement advertisements into a video in accordance with an embodiment of the present invention.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides improved systems and methods for inserting content into video programming. The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

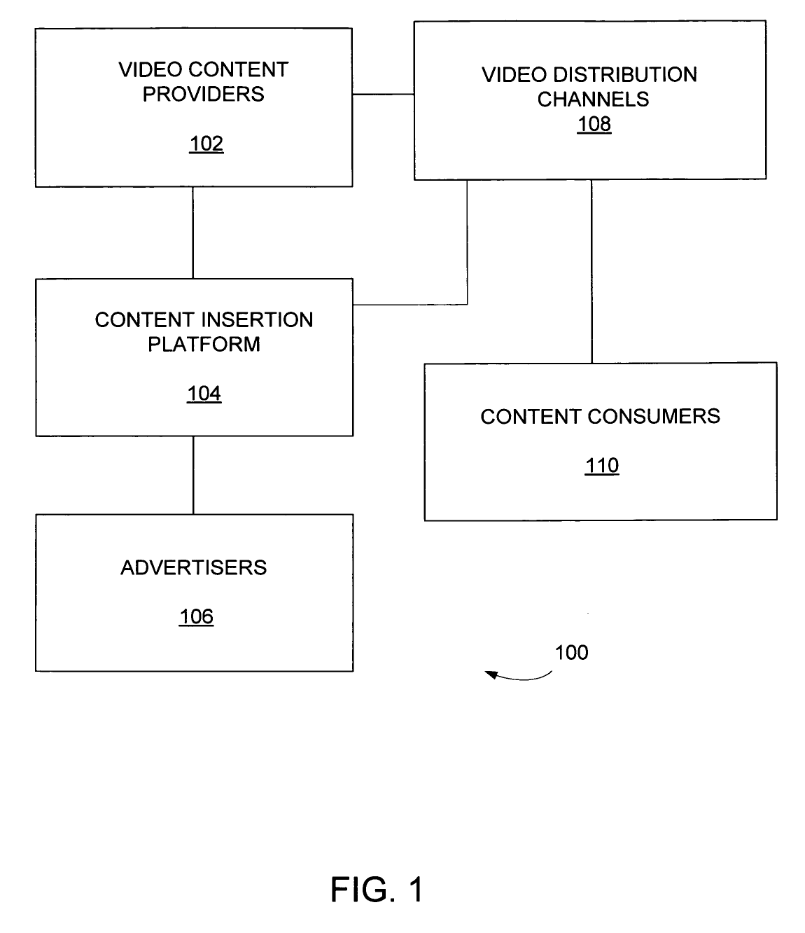

FIG. 1 illustrates a system 100 which represents an exemplary environment in which the present invention may be practiced. The system 100 includes video content providers 102. The video content providers 102 may be any entities involved with the creation, production or distribution of video content. Further, any video content may be appropriate for use with the present invention, including movies, television programming or streaming video. According to one embodiment, the video content providers 102 are responsible for assisting in the selection and insertion of adverting content into a piece of video.

The system 100 further includes advertisers 106. The advertisers 106 may be any entities interested in placing content into a video, including entities seeking to insert content for the purpose of advertising.

A content insertion platform 104 is also included in the system 100. The content insertion platform 104 is operable for communicating with the video content providers 102 and the advertisers 106. Any communication relationship may be acceptable for use with the present invention, including personal, telephonic or electronic communications. Communications over a network or the Internet may also be acceptable. The content insertion platform 104 may be any forum, interface or service that allows the providers 102 and the advertisers 106 to interact regarding insertion of content into a piece of video. As will be understood by those skilled in the art, the insertion platform 104 may provide a market environment, such as an auction, that brings together the video content providers 102 and the advertisers 106. In one embodiment, the insertion platform 104 may be developed to facilitate the insertion of product placement advertisements into videos. Further, the platform 104 may also be used to insert commercial break advertisements into videos.

As will be discussed in greater detail, the digital video providers 102 may submit information associated with a video to the content insertion platform 104. The advertisers 106 may then view this information and make proposals regarding the insertion of content into the video. The content insertion platform 104 may include techniques to facilitate this exchange of information and may also include authoring tools to automate the insertion of content into a video. Those skilled in the art will recognize that any number of tools and methods may be implemented with the content insertion platform 104 to enable an efficient exchange between the video content providers 102 and the advertisers 106.

The system 100 also includes video distribution channels 108 that communicate videos to content consumers 110. The video distribution channels 108 may include any means to communicate video media. These channels 108 include television, cable, satellite, DVD or videocassette distribution. The video distribution channels 108 may also include electronic communications over a network such as the Internet. In one embodiment of the present invention, the video distribution channels 108 receive the video content from either the video content providers 102 or the content insertion platform 104.

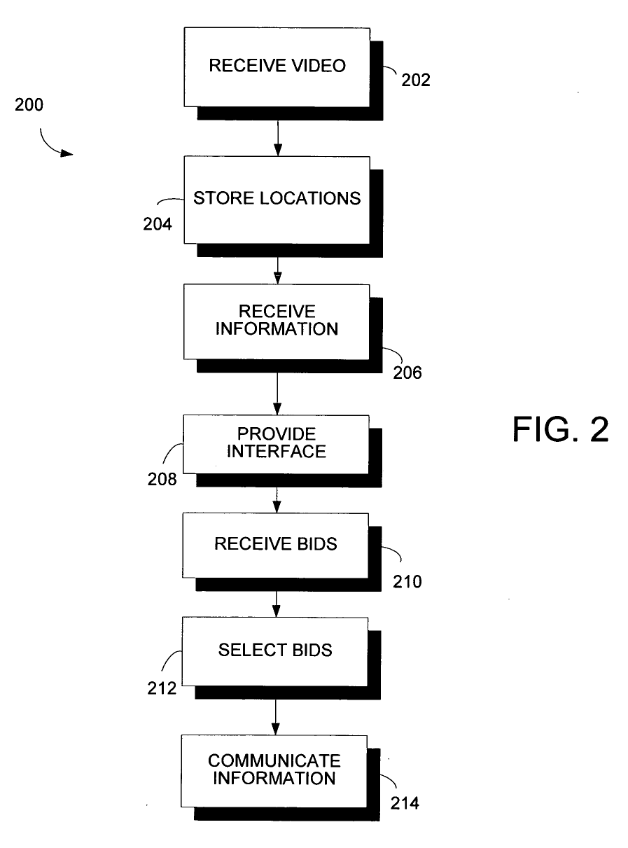

FIG. 2 illustrates a method 200 for managing insertion of content into a video. At 202, a portion of a video is received. Only a portion of content associated the video may be received, and the received video may be in an unfinished form. Those skilled in the art will recognize that any portion of the video may be received by the method 200. For example, a content provider may submit part of a video to a platform, such as the content insertion platform 104 of FIG. 1, for the purpose of dubbing product placement advertisements into the video. As previously mentioned, product placement advertisements refer to ads that are integrated into video content or ads that interact with the characters and objects in a program. Additional content may also be incorporated into a product placement ad, and client-side systems may be configured to accommodate user interaction with the ads. For example, product placement ads may allow a viewer to interact with the ad (e.g. by clicking on the ad) to view additional information about the product being advertised. As ads may be considered a point of sale and not just marketing, client systems may allow viewers to access content associated with the ads. This interaction may become more complex when an ad is integrated into the content. Further, there may be multiple ads on the screen at the same time. In one embodiment, a cursor on the screen, directed by a handheld device such as a remote control, may allow a user to select an ad. Those skilled in the art will appreciate that any number of client interfaces may be appropriate for permitting a user to interact with advertising content.

At 204, the method 200 stores data identifying locations (or slots) in the video where additional content may be inserted. Any data specifying an insertion location may be appropriate for the present invention. The data, for example, may be stored in a text file that lists a description of the insertion locations. The data may also be stored along with a copy of the video. For example, the data may be generated with an authoring tool that allows a user to digitally mark the locations on the video. For example, a t-shirt worn by an actor may be selected as a location where adverting content (i.e. a brand logo) may be inserted. The authoring tool may receive manual inputs from a user and may provide automated tools to facilitate the selection of the ad slots. Traditional commercial breaks ad slots may also be indicated with the authoring tool. Those skilled in the art will recognize that any number of currently available video editing tools may be employed to demarcate the selected locations.

Information describing the video is received at 206. The identified information may include information about the subject matter of the video, the actors in the video, the video's target audience and the expected distribution of the video. Further, the information may include a description of the identified insertion locations. In one embodiment, the information is tailored for use by advertisers. For example, information may describe a children's cartoon and may specify locations in the cartoon where advertisements can be placed. With this information, advertisers who promote their products to children can evaluate product placement opportunities in the cartoon. Of course, a variety of information describing the video may be acceptable for use with the present invention.

At 208, the method 200 provides an interface for allowing users to view at least a portion of the information and/or the video. Any known interface may be acceptable for use with the present invention. In one embodiment, users can access the interface via the Internet. Various interactive features may be included with the interface to facilitate a user's browsing of the information. These interactive features may include various search techniques. The interface may present information of interest to advertisers, may provide search capabilities tailored to advertisers or may present portions of the video which correspond with the identified insertion locations.

After viewing the information, users can submit offers related to placing a piece of additional content into one of the insertion locations, and, at 210, the offers or “bids” are received by the method 200. Any offer by a user related to inserting content may be considered a bid. A bid may include a monetary offer for the right to place the insertion content and may also include information about the additional content and/or the entity making the bid. For example, an insertion location may be suited for insertion of a brand logo associated with a fast food restaurant. Different advertisers representing fast food restaurants can submit offers advancing insertion of their restaurant's logo. The offers may include the amount of money they are willing to pay for insertion of their restaurant's logo, along with other information that may be useful in selecting an advertiser.

At 212, the method 200 selects a winning bid from the received bids. The winning bid represents the most attractive offer related to the insertion of content into an insertion location. As in a traditional auction, the winning bid may contain the highest monetary offer. However, different selection criteria may also be employed to select the winning bid. For example, the video content provider may prefer certain brands, and these preferred brands might get special treatment in the selection criteria. Those skilled in the art will recognize that any number of selection criteria may be used to choose the winning bid. These selection criteria may be programmed into a computer so as to automate the selection of the winning bid.

At 214, the method 200 communicates information associated with the winning bid to the content provider. With this information the content provider can decide whether or not to accept the bid/offer. Of course, some content may not be appropriate for an insertion location, and the content provider may reject bids associated with content it deems inappropriate. The content provider may reject the winning bid for any number of reasons. In one embodiment, if the content provider rejects the winning bid, the method 200 communicates information about other bids to the content provider until an acceptable bid is identified. If the content provider accepts the winning bid, content associated with the winning bid will be inserted into the video. The video provider, working directly with the user who made the bid, may accomplish the insertion of this content. In one embodiment, an intermediary such as the content insertion platform 104 of FIG. 1 may facilitate the content insertion. The intermediary may store the additional content and may provide tools to aid in the insertion of the content. Those skilled in the art will recognize that any number of currently available video editing tools may be employed to dub additional content into the video. Of course, the intermediary may also provide a wide variety of other services related to receiving bids and inserting content. Those skilled in the art will recognize that any number of services and tools may be provided to facilitate and coordinate the insertion of content into the video.

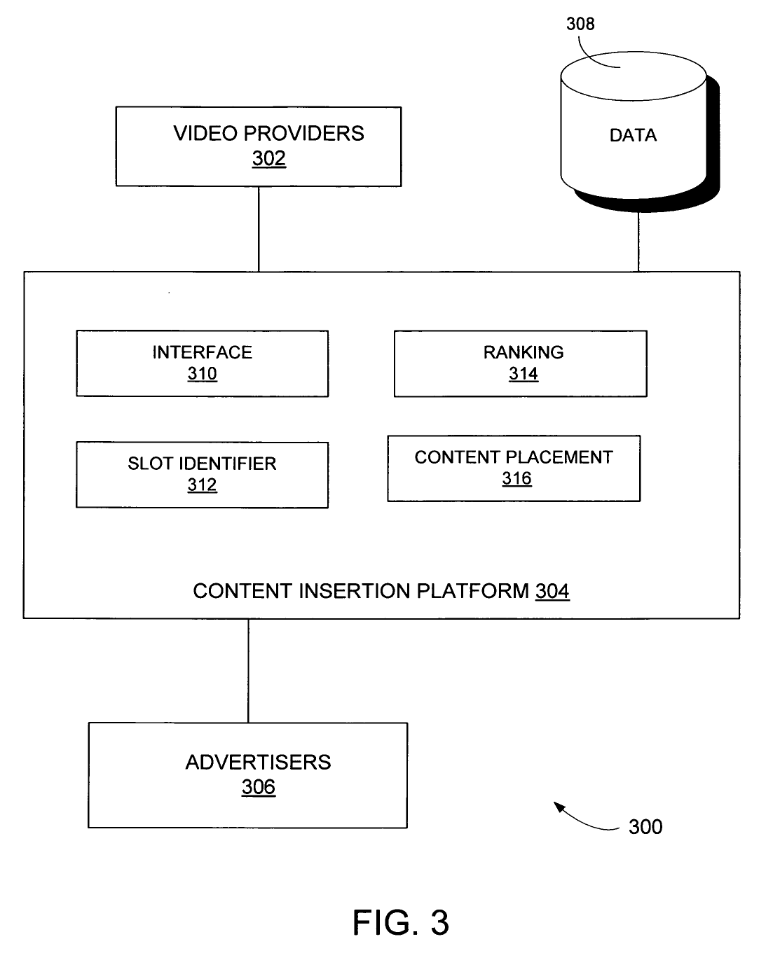

FIG. 3 illustrates a system 300 for managing insertion of content into videos. The system includes video providers 302 and advertisers 306. Similar to the previously discussed providers 102 and advertisers 106 of FIG. 1, the video providers 302 may be any entities involved with the creation, production or distribution of videos, while the advertisers 306 may be any entities interested in placing content into videos. In one embodiment, the video providers 302 represent media companies that generate revenue through placement of advertisements into their video programming. Further, the advertisers 306 represent entities that promote their products by inserting advertisements into media.

The system 300 also includes a content insertion platform 304. As with the content insertion platform 104 of FIG. 1, the content insertion platform 304 may be any forum, interface or service that allows the providers 302 and the advertisers 306 to interact regarding insertion of content into a piece of video. The content insertion platform 304 includes an interface component 310 to interact with the providers 302 and the advertisers 306. The interface component 310 may be accessible over a network such as the Internet or may require a local connection. The interface component 310 may receive a wide variety of information from the providers 302 and the advertisers 306. In one embodiment, the video providers 302 submit videos and other information via the interface component 310.

The content insertion platform 304 may store information submitted via the interface component 310 in a data store 308. The data store 308 may house videos, additional content such as product images or commercial break ads, and information describing submitted content. In one embodiment, the data store 308 is arranged as a searchable database capable of receiving a user's query and retrieving desired content.

The content insertion platform 304 also includes a slot identifier component 312. The slot identifier component 312 is configured to receive inputs identifying places or slots in the received videos where additional content, such as product placement advertisements, may be inserted. Further, commercial break ad slots may be identified for the insertion of commercial break ads. Once these ad slots are indicated, the video provider may submit additional information describing the slots.

In one embodiment, an authoring tool is included as part of the slot identifier component 312. One of the video providers 302 or another entity may utilize this authoring tool to mark locations in a video where additional content may be inserted. The authoring tool may include automated features to facilitate the marking of these locations. For example, the authoring tool may rely on historical data to automatically suggest insertion locations. For instance, the authoring tool may recognize a shape in a video as historically corresponding to a billboard. The authoring tool may then automatically mark this shape as a potential ad slot. As another example, a user may indicate a desire to mark an actress' dress as a location where a product logo may be inserted. Using the color of the dress or other characteristics, the authoring tool may be configured to automatically track the boundaries of the dress throughout a scene. Those skilled in the art will recognize that the discussed editing techniques are known in the art and that the authoring tool may include a wide variety of automated tools configured to locate, track and select items in a video.

The content insertion platform 304 further includes a ranking component 314 configured to rank requests from the advertisers 306. The requests may be received via the interface component 310, and they may relate to the right to insert content into an ad slot. In one embodiment, a bid may contain a monetary offer for the right to place additional content into a slot, though other information may also be included. To facilitate bidding, the content insertion platform 304 may provide a variety of information and tools to the advertisers 306. For example, the interface component 310 may provide search capabilities wherein a user may submit queries. Further, the advertisers 306 may review the submitted information and videos, along with information describing the ad slots.

Upon receiving a plurality of bids for an ad slot, the ranking component 314 is configured to rank the bids and to select a winning bid. While any number of selection criteria may be utilized to rank the bids, in one embodiment, the bidding system is an auction where the advertiser offering the most money is awarded the right to insert their content into a video.

A content placement component 316 is also included in the content insertion platform 304. The content placement component 316 may provide a variety of services related to the insertion of content into the video, and any number of video editing tools may be provided the by the content placement component 316. Further, inputs may be received from the providers 302, the advertisers 306 or other entities to accomplish the dubbing tasks. By providing editing means and a collaborative forum for the insertion of content into a video, the content placement component 316 is operable to output a video that includes inserted content. For example, an advertiser may have submitted a winning bid related to the insertion of a brand logo onto an actor's hat in a television program. Using the content placement component 316, the advertiser and the program's producer can submit inputs related to this insertion. Either party or another entity may use the editing tools provided by the content placement component 316 to insert the logo. Those skilled in the art will appreciate that any number of workflows or interactions between the parties may be appropriate to insert content into a video.

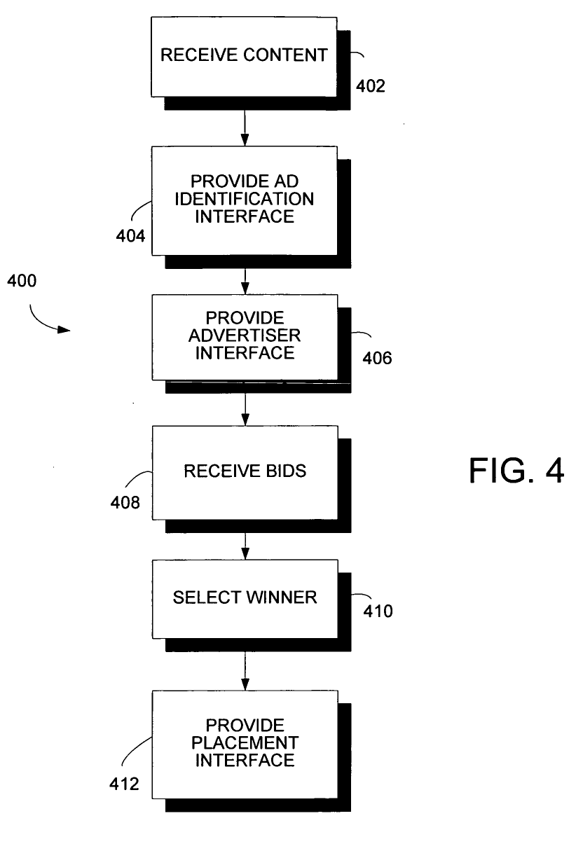

FIG. 4 provides a method 400 for inserting adverting content into a piece of media. At 402, the media is received from a media provider by the method 400. Any media may be submitted. For example, the producer of a television program may submit a copy of a show. The media need not be in a finalized form, and a mere script may be appropriate for receipt at 402.

At 404, an interface is provided for the media provider to submit information about the media. Any information that may be useful to advertisers in evaluating the media may be appropriate. Some examples of information that may be submitted are video footage, the studio, the director, the cast, the plot, the release channel and the release date. The interface may also be used to identify locations in the media where insertion of advertising content may be appropriate. The media provider may identify the insertions locations and may submit a description of these slots. The insertion locations may be indicated textually or on a copy of the media. As previously discussed, a variety of editing tools may be provided to assist in identifying ad locations, and a third party may assist in identifying the slots.

At 406, the method 400 provides an advertiser interface for allowing various advertisers to view information associated with the media and the identified ad locations. In one embodiment, advertisers can search the information for keywords or the interface may suggest media to the advertisers. In sum, any platform for allowing advertisers to view and traverse the information may be appropriate.

Once an advertiser finds an ad slot of interest, they may submit a bid to purchase the rights to insert advertising content into that slot, and at 408, the method 400 receives a plurality of bids from the advertisers. A bid may include a monetary offer for the right to place the advertising content into a slot and may also include information about the ad content and/or the entity making the bid.

At 410, the method 400 selects a winning bid. The winning bid may be the bid offering the most money or may be the most attractive bid based on a set of selection criteria. The advertiser that submitted the winning bid is provided the opportunity to have their ad content inserted into the media. The bids may be reviewed manually by the media provider or other entity. Further, a computer may automatically evaluate the bids. In one embodiment, the media provider is provided an opportunity to reject any bids before a winning bid is selected.

After a winning bid is selected, at 412, the method 400 provides a placement interface. The placement interface is configured to communicate information related to inserting advertising content into the selected ad location. Any communication interface allowing the advertiser and the media provider to interact may be appropriate, and the interface may provide the ability for the parties to confirm and approve the edited content. Further, third parties may also access the interface to aid in the insertion of the ad content. As previously discussed, a wide variety of editing tools are known in the art, and any number of these tools are acceptable for use with the placement interface.

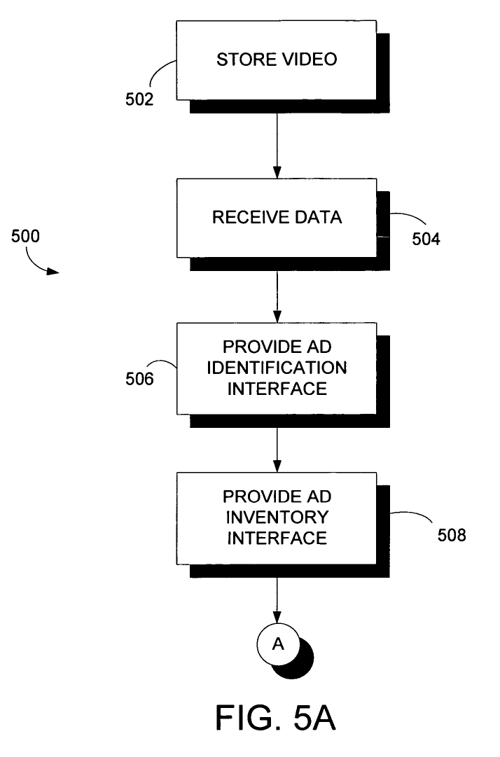

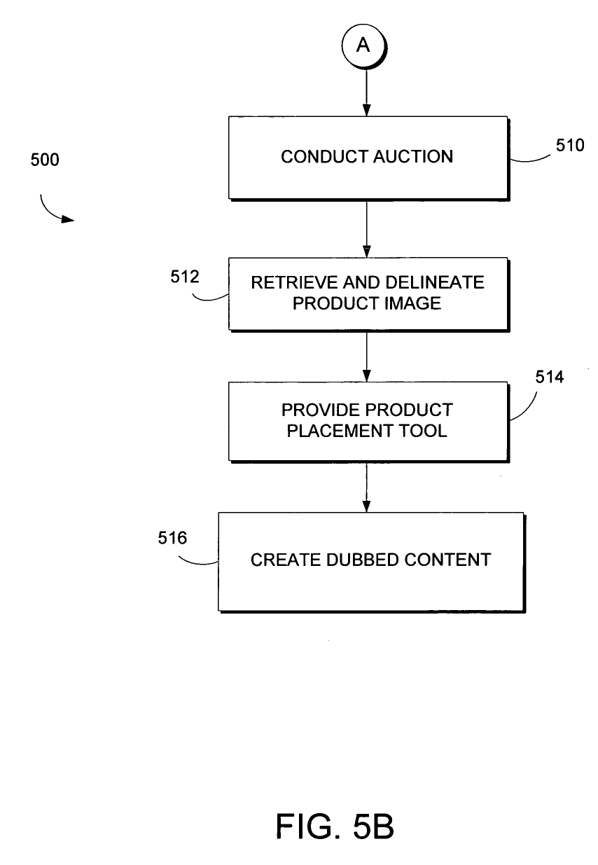

FIGS. 5A and 5B illustrate a method 500 for placing product placement advertisements into a video. At 502, a piece of video is stored in a database. The video may be any video footage which insertion of one or more product placement advertisements is desired. Additional data about a video is received at 504. Any data describing the video may be appropriate for receipt by the method 500, and the data may be designed to convey information of interest to potential advertisers.

At 506, the method 500 provides an ad identification interface. Using this interface, the video provider, advertisers or other entities can review the video and define locations (or slots) appropriate for insertion of advertising content. For example, the interface may provide simple drawing tools for users to mark potential slots. More sophisticated tools may also be used with the interface to identify places where advertising content may be inserted.

An ad inventory interface is provided at 508. With this interface, advertisers can browse and evaluate the various identified ad slots. In one embodiment, a wide variety of videos are received by the method 500, and a searchable database stores information associated with the inventory of available ad slots. To search the database, the interface includes a search utility. Any number of search technologies known in the art may be appropriate for use with the present invention, and the search query may traverse the database and return data associated with the submitted videos and their identified slots.

At 510, the method 500 conducts an auction in which advertisers can bid on the right to place their advertising content into an identified ad slot. Computerized and non-computerized auctions are well known in the art, and any number of auction rules or criteria may be implemented by the method 500. For example, an Internet-based platform may communicate information about an auction, including the current highest bid and the time remaining to bid. At the conclusion of the auction, a winning advertiser is selected and advertising content associated with the winning advertiser is placed into the ad slot.

At 512, a product image associated with the winning advertiser is retrieved from a database. In one embodiment, before bidding on slots each advertiser submits various images to a product image database. Upon an advertiser's selection, the stored images are retrieved from the product placement database for placement into the video. An ad-polishing tool may also be utilized to manipulate the product image. The ad-polishing tool may accomplish a variety of reshaping and delineations, and these manipulations may be tailored to the characteristics of the identified ad slot. The database may also include commercials for insertion into a commercial break ad slot.

The method 500 provides a product placement tool at 514. This tool is operable to receive the polished product image and to facilitate its insertion into the video. As previously discussed, any number of video editing techniques known in the art may be utilized to dub the advertising content into the video. Upon completion, the ad-dubbed video is created at 516. This video may be presented to the video provider and the advertiser for confirmation and approval. If the video is acceptable, it may be released for distribution, or it may be re-inserted into the video database for additional advertising content to be inserted.

Alternative embodiments and implementations of the present invention will become apparent to those skilled in the art to which it pertains upon review of the specification, including the drawing figures. The present invention may utilize a reverse auction in place of a traditional auction to select a product placement advertisement. In another embodiment, the identification of ad slots and/or the insertion of advertising content may be accomplished by a content distributor, such as a television station. In this embodiment, input from the content provider may be minimized. Accordingly, the scope of the present invention is defined by the appended claims rather than the foregoing description.

The invention claimed is:

1. A computer-implemented method for managing insertion of content into a video, the method comprising:
receiving at least a portion of said video from a content provider;
storing data identifying one or more insertion locations in said video;
receiving information from said content provider describing said video or said one or more insertion locations;
providing an interface for allowing users to view at least a portion of said information or at least a portion of said video;
receiving a plurality of bids from said users, wherein each of said plurality of bids relates to insertion of additional content into one of said one or more insertion locations;
selecting a winning bid from said plurality of bids; and
communicating information associated with said winning bid to said content provider.

2. The computer-implemented method of claim 1, wherein said users includes one or more entities seeking to advertise a product or a service.

3. The computer-implemented method of claim 1, wherein at least a portion of said one or more insertion locations are commercial break ad slots.

4. The computer-implemented method of claim 1, further comprising providing a video editing tool configured to received inputs related to manipulation of the content in said video.

5. The computer-implemented method of claim 4, wherein said video editing tool provides controls for identifying said one or more insertion locations.

6. The computer-implemented method of claim 4, wherein said video editing tool provides controls for inserting content into one of said one or more insertion locations.

7. The computer-implemented method of claim 1, wherein said selecting the winning bid includes conducting an auction utilizing said plurality of bids.

8. One or more computer-readable media having computer-useable instructions embodied thereon to perform the method of claim 1.

9. A computer system for managing insertion of content into one or more videos, the system comprising:
one or more data stores that contain one or more videos;
a slot identification component configured to receive inputs identifying one or more slots in said one or more videos;
a ranking component configured to rank requests from one or more users, wherein each of said requests includes an offer seeking for additional content to be inserted into one of said slots; and
a content placement component configured to insert at least a portion of said additional content into one of said slots.

10. The computer system of claim 9, wherein said ranking component is configured to conduct an auction to select a winning request.

11. The computer system of claim 10, wherein said content placement component is configured to insert the additional content associated with said winning request into one of said slots.

12. The computer system of claim 9, wherein said a content placement component includes a video authoring tool component configured to provide controls for manipulating content in said one or more videos.

13. The computer system of claim 9, wherein at least a portion of said one or more pieces of additional content includes content associated with a product placement advertisement.

14. The computer system of claim 9, further comprising an interface component configured to receive inputs from said one or more users.

15. The computer system of claim 14, wherein said interface component is configured to receive inputs via the Internet.

16. A method for inserting advertising content into a piece of media, the method comprising:
identifying one or more ad locations in said piece of media, wherein said one or more ad locations are portions of said piece of media selected for insertion of advertising content;
providing an advertiser interface for allowing one or more advertisers to view information associated with said piece of media or said one or more ad locations;
receiving a plurality of bids from said one or more advertisers, wherein each of said bids includes a request to insert advertising content into one of said one or more ad locations;
selecting a winning bid from said plurality of bids; and
providing an insertion interface for controlling insertion of advertising content associated with said winning bid into at least one of said one or more ad locations.

17. The method of claim 16, wherein said advertiser interface is configured to receive search queries from said one or more advertisers.

18. The method of claim 16, wherein said advertiser interface is accessible over the Internet.

19. The method of claim 16, wherein said selecting a winning bid includes conducting an auction.

20. The method of claim 16, wherein said insertion interface includes one or more editing tools for modifying said piece of media.
